(19) United States
(12) Patent Application Publication
(10) Pub. No.: US 2011/0206115 A1
(43) Pub. Date: Aug. 25, 2011

(54) ENCODING APPARATUS, ENCODING METHOD AND ENCODING PROGRAM

(76) Inventors: Akihiro OKUMURA, Kanagawa (JP); Hideki Ohtsuka, Kanagawa (JP)

(21) Appl. No.: 13/028,521

(22) Filed: Feb. 16, 2011

(30) Foreign Application Priority Data
Feb. 22, 2010 (JP) P2010-035825

(51) Int. Cl. H04N 7/12

(52) U.S. Cl. 375/240.03; 375/E07.126; 375/E07.132

(57) ABSTRACT

Disclosed herein is a data encoding apparatus including a transform encoding section; a quantization-scale computation section; a feature-quantity extraction section; a quantization-scale adjustment section; and a quantization section.

### BACKGROUND OF THE INVENTION

1. Field of the Invention

In general, the present invention relates to an encoding apparatus, an encoding method and an encoding program. More particularly, the present invention relates to an encoding apparatus capable of improving the picture quality of a block exhibiting easily-noticeable visual deteriorations, relates to an encoding method adopted by the encoding apparatus and relates to an encoding program implementing the encoding method.

2. Description of the Related Art

Accompanying progress made in the multimedia field in recent years, a variety of moving-picture compression encoding methods have been proposed. Representatives of the moving-picture compression encoding methods are MPEG (Moving Picture Expert Group)-1, 2, 4 and H.264 (ITU-T Q6/16 VCEG). In compression encoding processing based on these moving-picture compression encoding methods, a raw picture is divided into a plurality of predetermined areas which are each referred to as a block. The compression encoding processing includes movement prediction processing and DCT transformation processing which are carried out for each of the blocks. It is to be noted that, in the movement prediction processing, already encoded picture data needs to be compared with a reference picture which has been obtained as a result of local decoding processing. It is thus necessary to decode the already encoded picture data prior to the comparison.

In the case of compression encoding processing carried out on a picture in conformity with an MPEG method, in many cases, the code quantity much varies in accordance with the spatial frequency characteristic, the scene and the quantization scale value which are properties of the picture itself. In implementation of an encoding apparatus with encoding characteristics proper for such picture properties, a technology of importance to decoding processing carried out to result in a good quality picture is a code-quantity control technology.

As an algorithm of the code-quantity control, a TM5 (Test Model 5) algorithm is generally adopted. In the TM5 algorithm, a spatial activity is used as a feature quantity expressing the complexity of the picture. In accordance with the TM5 algorithm, a picture is selected from a GOP (group of pictures) and a large code quantity is allocated to the selected picture. Then, a large code quantity is further allocated to a flat portion of the selected picture. The flat portion exhibits easily-noticeable visual deteriorations. That is to say, the flat portion is a portion having a low spatial activity. Thus, within a bit-rate range determined in advance, it is possible to carry out code-quantity control for avoiding deteriorations of the picture quality and quantization control.

In addition, there have also been proposed other techniques each used for carrying out quantization control in accordance with the characteristics of the picture in the same way as the TM5 algorithm. For more information on these other techniques, the reader is advised to refer to Japanese Patent Laid-open Nos. Hei 11-196417 and 2009-200871.

### SUMMARY OF THE INVENTION

In the existing quantization control, a spatial activity is used as means for extracting a block which exhibits easily-noticeable visual deteriorations. Since the spatial activity itself is a feature quantity obtained by crossbreeding the amplitude and frequency of a waveform, in some cases, the spatial activity does not necessarily match a block which exhibits easily-noticeable visual deteriorations. That is to say, in the existing quantization control which makes use of the spatial activity, a block including an edge generating high-frequency components cannot be extracted in some cases.

Addressing the problem described above, inventors of the present invention have proposed a data encoding apparatus capable of improving the picture quality of a block which exhibits easily-noticeable visual deteriorations. In addition, the inventors have also proposed to a data encoding method adopted by the data encoding apparatus and a data encoding program implementing the data encoding method.

In accordance with a first mode of the present invention, there is provided a data encoding apparatus employing:

transform encoding means for dividing input picture data into a plurality of blocks and carrying out a transform encoding process on each of the blocks in order to output transform coefficient data;

quantization-scale computation means for computing a reference value of a quantization scale of the block on the basis of a difference between a target code quantity and an actually-generated-code quantity;

feature-quantity extraction means for computing a feature quantity representing the degree of noticeability of visual deteriorations in the block and computing an offset of the quantization scale of the block on the basis of the computed feature quantity;

quantization-scale adjustment means for adjusting a reference value computed by the quantization-scale computation means as the reference value of the quantization scale on the basis of an offset computed by the feature-quantity extraction means as the offset of the quantization scale; and

quantization means for quantizing the transform coefficient data output by the transform encoding means for each of the blocks in accordance with a reference value adjusted by the quantization-scale adjustment means as the reference value of the quantization scale.

In accordance with the first mode of the present invention, there is also provided data encoding method to be adopted by a data encoding apparatus configured to encode input picture data to serve as a method having the steps of:

dividing input picture data into a plurality of blocks and carrying out a transform encoding process on each of the blocks in order to output transform coefficient data;

computing a reference value of a quantization scale of the block on the basis of a difference between a target code quantity and an actually-generated-code quantity;

computing a feature quantity representing the degree of noticeability of visual deteriorations in the block and computing an offset of the quantization scale of the block on the basis of the computed feature quantity;

adjusting a reference value computed at the quantization-scale computation step as the reference value of the quantization scale on the basis of an offset computed at the feature-quantity extraction step as the offset of the quantization scale; and

quantizing the transform coefficient data output at the transform encoding step for each of the blocks in accordance with a reference value adjusted at the quantization-scale adjustment step as the reference value of the quantization scale.

In accordance with the first mode of the present invention, there is also provided a data encoding program to be executed by a computer to perform processing including:

a transform encoding step of dividing input picture data into a plurality of blocks and carrying out a transform encoding process on each of the blocks in order to output transform coefficient data;

a quantization-scale computation step of computing a reference value of a quantization scale of the block on the basis of a difference between a target code quantity and an actually-generated-code quantity;

a feature-quantity extraction step of computing a feature quantity representing the degree of noticeability of visual deteriorations in the block and computing an offset of the quantization scale of the block on the basis of the computed feature quantity;

a quantization-scale adjustment step of adjusting a reference value computed at the quantization-scale computation step as the reference value of the quantization scale on the basis of an offset computed at the feature-quantity extraction step as the offset of the quantization scale; and

a quantization step of quantizing the transform coefficient data output at the transform encoding step for each of the blocks in accordance with a reference value adjusted at the quantization-scale adjustment step as the reference value of the quantization scale.

In the data encoding apparatus, the data encoding method and the data encoding program which are provided in accordance with the first mode of the present invention, input picture data is divided into a plurality of blocks and a transform encoding process is carried out on each of the blocks in order to output transform coefficient data. Then, a reference value of a quantization scale of the block is computed on the basis of a difference between a target code quantity and an actually-generated-code quantity. Subsequently, a feature quantity representing the degree of noticeability of visual deteriorations in the block is computed and an offset of the quantization scale of the block is computed on the basis of the computed feature quantity. Then, the computed reference value of the quantization scale is adjusted on the basis of the computed offset of the quantization scale. Finally, the output transform coefficient data is quantized for each of the blocks in accordance with the adjusted reference value of the quantization scale.

In accordance with a second mode of the present invention, there is provided a data encoding apparatus including:

transform encoding means for dividing input picture data into a plurality of blocks and carrying out a transform encoding process on each of the blocks in order to output transform coefficient data;

entire-screen feature-quantity extraction means for computing entire-screen feature quantities representing the flatness of an entire screen of the input picture data;

quantization-scale computation means for computing a reference value of a quantization scale of the block on the basis of a difference between a target code quantity and an actually-generated-code quantity;

feature-quantity extraction means for computing a feature quantity representing the flatness of the block and computing an offset of the quantization scale of the block in accordance with a relative degree determined by comparison of the flatness of the block with the flatness of the entire screen to serve as the relative degree of the flatness of the block;

quantization-scale adjustment means for adjusting a reference value computed by the quantization-scale computation means as the reference value of the quantization scale on the basis of an offset computed by the feature-quantity extraction means as the offset of the quantization scale;

quantization means for quantizing the transform coefficient data output by the transform encoding means for each of the blocks in accordance with a reference value adjusted by the quantization-scale adjustment means as the reference value of the quantization scale.

In the data encoding apparatus provided in accordance with the second mode of the present invention, input picture data is divided into a plurality of blocks and a transform encoding process is carried out on each of the blocks in order to output transform coefficient data. Subsequently, an entire-screen feature quantity representing the flatness of an entire screen of the input picture data is computed. Then, a reference value of a quantization scale of the block is computed on the basis of a difference between a target code quantity and an actually-generated-code quantity. Subsequently, a feature quantity representing the flatness of the block is computed and an offset of the quantization scale of the block is computed in accordance with a relative degree determined by comparison of the flatness of the block with the flatness of the entire screen to serve as the relative degree of the flatness of the block. Then, the computed reference value of the quantization scale is adjusted on the basis of the computed offset of the quantization scale. Finally, the output transform coefficient data is quantized for each of the blocks in accordance with the adjusted reference value of the quantization scale.

It is to be noted that the data encoding program can be presented to the user by transmitting the program through a transmission medium or by recording the program onto a recording medium in advance and giving the recording medium to the user.

The data encoding apparatus can be designed as a standalone apparatus or configured from internal blocks which compose one apparatus.

In accordance with the first and second modes of the present invention, it is possible to improve the picture quality of a block which exhibits easily-noticeable visual deteriorations.

### BRIEF DESCRIPTION OF THE DRAWINGS

FIG. 1 is a block diagram showing a typical configuration of an embodiment implementing a data encoding apparatus to which the present invention is applied;

FIG. 2 is a block diagram showing a detailed typical configuration of an entire-screen feature-quantity extraction section employed in the data encoding apparatus;

FIG. 3 is a diagram showing typical division of a picture of one screen into a plurality of MB (macroblock) units;

FIG. 4 is a diagram showing a macroblock MB divided into a plurality of sub-blocks SB;

FIG. 5 is a diagram showing typical local areas LB each set at one of possible positions in a sub-block SB;

FIG. 6 is a diagram showing a typical local area LB set at one of possible positions in a sub-block SB;

FIG. 7 is an explanatory diagram to be referred to in description of processing to compute a macroblock dynamic range MDR of a macroblock MB;

FIG. 8 is a block diagram showing a detailed typical configuration of a feature-quantity extraction section employed in the data encoding apparatus;

FIG. 9 is an explanatory diagram to be referred to in description of processing carried out by a swing-width computation section;

FIG. 10 shows an explanatory flowchart to be referred to in description of quantization-parameter determination processing;

FIG. 11 shows an explanatory flowchart to be referred to in description of offset computation processing;

FIG. 12 is an explanatory diagram to be referred to in description of effects provided by the embodiments of the present invention;

FIG. 13 is a diagram showing other typical local areas LB each set at one of possible positions in a sub-block SB;

FIG. 14 is an explanatory diagram to be referred to in description of effects provided by the present invention; and

FIG. 15 is a block diagram showing a typical configuration of an embodiment implementing a computer to which the present invention is applied.

### DETAILED DESCRIPTION OF THE PREFERRED EMBODIMENTS

### Typical Configuration of the Data Encoding Apparatus

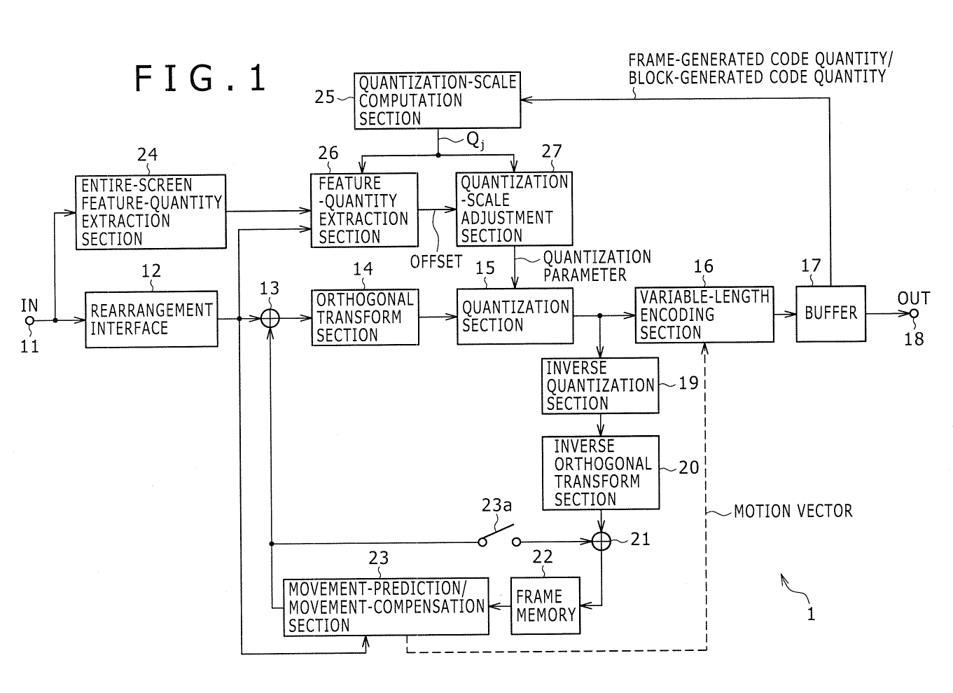

FIG. 1 is a block diagram showing a typical configuration of an embodiment implementing a data encoding apparatus 1 to which the present invention is applied.

Input picture data is supplied to an input terminal 11 employed in the data encoding apparatus 1. The input picture data is the data of a picture to be encoded. The input picture data is a signal having the ordinary video picture format. Typical examples of the ordinary video picture format is the interlace format and the progressive format.

A rearrangement section 12 temporarily stores the input picture data in a memory and, as required, reads out the data from the memory in order to rearrange the data into a frame (field) order according to the encoding-subject picture types. The rearrangement section 12 then supplies the picture data rearranged into the frame (field) order according to the encoding-subject picture types to a subtractor 13 in MB (macroblock) units. The size of the macroblock MB is determined in accordance with the data encoding method. For example, the macroblock MB has a typical size of 16×16 pixels or 8×8 pixels. In the case of this embodiment, the macroblock MB has the typical size of 16×16 pixels.

If the encoding-subject picture type of picture data is the type conforming to the frame internal encoding method (or the intra encoding method), the subtractor 13 passes on the picture data received from the rearrangement section 12 to an orthogonal transform section 14 as it is. If the encoding-subject picture type of picture data is the type conforming to the inter-frame encoding method (or the inter encoding method), on the other hand, the subtractor 13 subtracts predicted-picture data supplied by a movement-prediction/movement-compensation section 23 from the picture data received from the rearrangement section 12 and supplies a picture-data difference obtained as a result of the subtraction to the orthogonal transform section 14.

The orthogonal transform section 14 carries out an orthogonal transform process on data output by the subtractor 13 in MB (macroblock) units and supplies transform coefficient data obtained as a result of the orthogonal transform process to a quantization section 15. As is obvious from the above description, the data output by the subtractor 13 can be picture data or a picture-data difference.

The quantization section 15 quantizes the transform coefficient data received from the orthogonal transform section 14 in accordance with a quantization parameter received from a quantization-scale adjustment section 27, supplying quantized transform coefficient data to a variable-length encoding section 16 and an inverse quantization section 19.

The variable-length encoding section 16 carries out a variable-length encoding process on the quantized transform coefficient data received from the quantization section 15. Then, the variable-length encoding section 16 multiplexes data including motion-vector data received from the movement-prediction/movement-compensation section 23 with encoded data obtained as a result of the variable-length encoding process and supplies multiplexed encoded data obtained as a result of the multiplexing to a buffer 17. The motion-vector data received from the movement-prediction/movement-compensation section 23 is motion-vector data for movement compensation. The buffer 17 is a memory used for temporarily stored the multiplexed encoded data received from the variable-length encoding section 16. The multiplexed encoded data is sequentially read out from the buffer 17 and supplied to an output terminal 18.

The inverse quantization section 19 carries out an inverse quantization process on the quantized transform coefficient data received from the quantization section 15 and supplies transform coefficient data obtained as a result of the inverse quantization process to an inverse orthogonal transform section 20. The inverse orthogonal transform section 20 carries out an inverse orthogonal transform process on the transform coefficient data received from the inverse quantization section 19 and supplies data obtained as a result of the inverse orthogonal transform process to an adder 21. If the encoding-subject picture type is the type conforming to the frame internal encoding method (or the intra encoding method), the adder 21 passes on the data received from the inverse orthogonal transform section 20 to a frame memory 22 as it is. In this case, the data received from the inverse orthogonal transform section 20 is picture data. If the encoding-subject picture type is the type conforming to the inter-frame encoding method (or the inter encoding method), on the other hand, the adder 21 adds predicted data received from the movement-prediction/movement-compensation section 23 to the data received from the inverse orthogonal transform section 20 and supplies the sum to the frame memory 22. In this case, the data received from the inverse orthogonal transform section 20 is the picture-data difference cited before. The predicted data is picture data obtained as a result of an earlier decoding process. Thus, in this case, the adder 21 adds the predicted data to the picture-data difference in order recover picture data from the picture-data difference. That is to say, the data output by the adder 21 as the sum is picture data obtained as a result of a local decoding process. The picture data obtained as a result of a local decoding process is also referred to as a locally decoded picture data.

The frame memory 22 is used for storing data output by the adder 21 by dividing the data into a plurality of frame units. As is obvious from the description given above, the data output by the adder 21 can be picture data output by the inverse orthogonal transform section 20 in the case of the intra encoding process or the locally decoded picture data in the case of the inter encoding process. In the case of the inter encoding process, the movement-prediction/movement-compensation section 23 makes use of a picture represented by the locally decoded picture data stored in the frame memory 22 as a reference picture and compares the reference picture with the present picture represented by picture data received from the rearrangement section 12 in order to predict a movement and compute the aforementioned predicted-picture data completing movement compensation. Then, the movement-prediction/movement-compensation section 23 supplies the computed predicted-picture data to the subtractor 13. The movement-prediction/movement-compensation section 23 also supplies the aforementioned motion-vector data of the computed predicted-picture data to the variable-length encoding section 16.

In addition, the movement-prediction/movement-compensation section 23 supplies the computed predicted-picture data to the adder 21 by way of a switch 23a if necessary. That is to say, the movement-prediction/movement-compensation section 23 controls the switch 23a in accordance with the decoding-subject picture type. To put it more concretely, if the encoding-subject picture type is the type conforming to the inter-frame encoding method, that is, in the case of the inter encoding process, the movement-prediction/movement-compensation section 23 puts the switch 23a in a turned-on state which allows the computed predicted-picture data to be supplied to the adder 21.

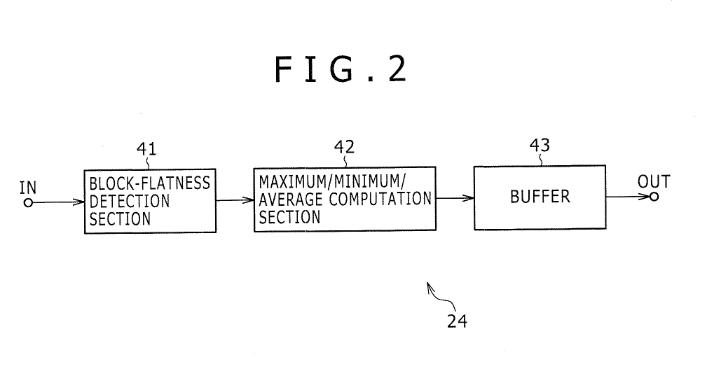

As entire-screen feature quantities which are defined as feature quantities showing the flatness of the entire screen, an entire-screen feature-quantity extraction section 24 computes the maximum value ldrMax of the macroblock dynamic ranges MDR of pixel values computed for all pixels on the entire screen by adoption of a method determined in advance, the minimum value ldrMin of the macroblock dynamic ranges MDR and the average value ldrAve of the macroblock dynamic ranges MDR. The entire-screen feature-quantity extraction section 24 temporarily saves the computed entire-screen feature quantities and, then, for frames rearranged and output by the rearrangement section 12, the entire-screen feature-quantity extraction section 24 sequentially outputs the temporarily saved entire-screen feature quantities to a feature-quantity extraction section 26. Details of the method adopted by the entire-screen feature-quantity extraction section 24 to compute the entire-screen feature quantities will be described later by referring to diagrams which serve as FIGS. 2 to 7.

A quantization-scale computation section 25 refers to the amount of data stored in the buffer 17 and other information in order to acquire a frame-generated code quantity. Then, the quantization-scale computation section 25 determines a target code quantity in accordance with the acquired frame-generated code quantity. To put it more concretely, the quantization-scale computation section 25 takes a bit count for unencoded pictures in a GOP as a base and allocates a bit count to each picture in the GOP. The unencoded pictures in the GOP include a picture which serves as an object of the bit-count allocation. The quantization-scale computation section 25 allocates a bit count to a picture in the GOP repeatedly in the encoding order of pictures in the GOP. In this way, the quantization-scale computation section 25 sets a picture target code quantity for every picture.

In addition, the quantization-scale computation section 25 also refers to the amount of data supplied by the variable-length encoding section 16 to the buffer 17 in order to acquire a block-generated code quantity which is defined as the amount of code generated for a MB (macroblock) unit. Then, the quantization-scale computation section 25 initially computes the difference between a target code quantity set for every picture and an actually-generated-code quantity in order to make the target code quantity match the actually-generated-code quantity. Subsequently, the quantization-scale computation section 25 computes the reference value of a quantization scale for every macroblock MB from the difference between the target code quantity and the actually-generated-code quantity. In the following description, the reference value of a quantization scale is also referred to as the reference value of a Q scale. The reference value of the Q scale in a jth macroblock MB of the current picture is denoted by reference notation Qⱼ. The quantization-scale computation section 25 supplies the computed reference value Qⱼ of the Q scale to the feature-quantity extraction section 26 and a quantization-scale adjustment section 27.

The quantization-scale computation section 25 supplies the reference value Qⱼ of the Q scale to the feature-quantity extraction section 26 as a quantization parameter. In addition, the entire-screen feature-quantity extraction section 24 provides the feature-quantity extraction section 26 with the entire-screen feature quantities which are the maximum value ldrMax of the macroblock dynamic ranges MDR of pixel values computed for the entire screen by adoption of a method determined in advance, the minimum value ldrMin of the macroblock dynamic ranges MDR and the average value ldrAve of the macroblock dynamic ranges MDR. On top of that, the rearrangement section 12 provides the feature-quantity extraction section 26 with macroblock data which is the data of an MB (macroblock) unit of a picture (or a screen) corresponding to the entire-screen feature quantities supplied by the entire-screen feature-quantity extraction section 24.

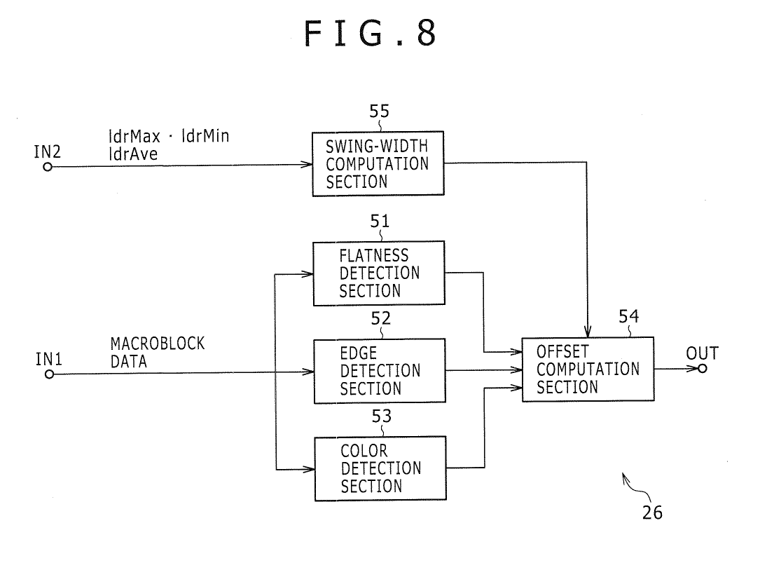

The feature-quantity extraction section 26 computes an offset OFFSET for the quantization parameter supplied by the quantization-scale computation section 25 as the reference value Qⱼ of the Q scale and outputs the offset OFFSET to the quantization-scale adjustment section 27. To put it more concretely, the feature-quantity extraction section 26 computes an offset OFFSET in accordance with a relative degree determined by comparison of the flatness of the macroblock MB with the flatness of the entire screen to serve as the relative degree of the flatness of the macroblock MB. Details of the processing carried out by the feature-quantity extraction section 26 will be explained later by referring to diagrams including a diagram which serves as FIG. 8.

The quantization-scale adjustment section 27 adjusts the quantization parameter, which is received from the quantization-scale computation section 25 as the reference value Qⱼ of the Q scale, on the basis of the offset OFFSET received from the feature-quantity extraction section 26 in order to generate an adjusted reference value Qⱼ′ of the Q scale. The quantization-scale adjustment section 27 supplies the adjusted reference value Qⱼ′ of the Q scale to the quantization section 15.

The flatter the picture of the entire screen and the picture of the macroblock MB, the higher the degree to which the offset OFFSET received from the feature-quantity extraction section 26 reduces the reference value Qⱼ of the Q scale in order to generate the adjusted reference value Qⱼ′ of the Q scale in the quantization-scale adjustment section 27. In addition, the smaller the adjusted reference value Qⱼ′ of the Q scale, that is, the smaller the adjusted quantization parameter, the more the amount of the allocated code.

In the data encoding apparatus 1 having the configuration described above, the picture is encoded by adjusting the quantization parameter in accordance with a relative degree determined by comparison of the flatness of the picture on the block with the flatness of the picture on the entire screen to serve as the relative degree of the flatness of the picture on the block. It is to be noted that the degree of the flatness of a picture represents the complexity of the picture.

### Typical Configuration of the Entire-Screen Feature-Quantity Extraction Section 24

Next, details of the entire-screen feature-quantity extraction section 24 are explained.

FIG. 2 is a block diagram showing a detailed typical configuration of the entire-screen feature-quantity extraction section 24 employed in the data encoding apparatus 1.

As shown in the figure, the entire-screen feature-quantity extraction section 24 employs a block-flatness detection section 41, a maximum/minimum/average computation section 42 and a buffer 43.

The block-flatness detection section 41 divides a picture of one screen into MB (macroblock) units which each have a size of 16×16 pixels. Then, for each of the macroblocks MB obtained as a result of the division, the block-flatness detection section 41 computes a macroblock dynamic range MDR which represents the characteristic of the macroblock MB. Subsequently, the block-flatness detection section 41 supplies the macroblock dynamic range MDR to the maximum/minimum/average computation section 42. To put it more concretely, the macroblock dynamic range MDR of a macroblock MB is the difference between the maximum of pixel values of pixels in an area determined in advance and the minimum of the pixel values. In this case, the area determined in advance is the macroblock MB. That is to say:

MDR=Maximum value−Minimum value

The maximum/minimum/average computation section 42 computes the maximum value ldrMax of the macroblock dynamic ranges MDR received from the block-flatness detection section 41 as the macroblock dynamic ranges MDR of the macroblocks MB composing one screen, the minimum value ldrMin of the macroblock dynamic ranges MDR and the average value ldrAve of the macroblock dynamic ranges MDR. Then, the maximum/minimum/average computation section 42 supplies the maximum value ldrMax, the minimum value ldrMin of the macroblock dynamic ranges MDR and the average value ldrAve to the buffer 43.

The buffer 43 is used for storing the maximum value ldrMax of the macroblock dynamic ranges MDR of the macroblocks MB composing one screen, the minimum value ldrMin of the macroblock dynamic ranges MDR and the average value ldrAve of the macroblock dynamic ranges MDR for each of a plurality of frames. Then, the maximum value ldrMax of the macroblock dynamic ranges MDR of the macroblocks MB composing one screen, the minimum value ldrMin of the macroblock dynamic ranges MDR and the average value ldrAve of the macroblock dynamic ranges MDR are read out from the buffer 43 for a frame corresponding to MB (macroblock) data output by the rearrangement section 12 and supplied to the feature-quantity extraction section 26.

### Processing of the Entire-Screen Feature-Quantity Extraction Section 24

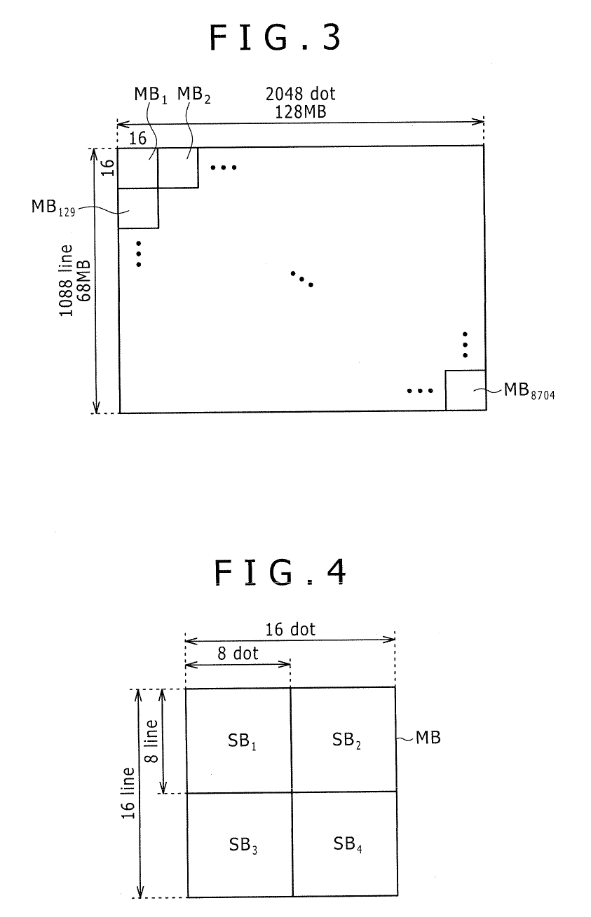

Processing carried out by the entire-screen feature-quantity extraction section 24 is explained in detail by referring to FIGS. 3 to 7 as follows.

FIG. 3 is a diagram showing typical division of a picture of one screen into a plurality of MB (macroblock) units. The MB (macroblock) units are thus a result of a process carried out by the block-flatness detection section 41 to divide the picture of one screen. It is to be noted that, in the case of the MB (macroblock) units shown in the diagram which serves as FIG. 3, the resolution of the input picture data supplied to the entire-screen feature-quantity extraction section 24 is 1080/60p.

If the resolution of the input picture data supplied to the entire-screen feature-quantity extraction section 24 is 1080/60p, the block-flatness detection section 41 divides the picture of one screen into 8,704 (=128×68) macroblocks MB, i.e., macroblocks MB₁ to MB₈₇₀₄.

FIG. 4 is a diagram showing a macroblock MB divided into a plurality of sub-blocks SB. The macroblock MB divided into a plurality of sub-blocks SB is one of the macroblocks MB₁ to MB₈₇₀₄. It is to be noted that, since all the macroblocks MB₁ to MB₈₇₀₄ are subjected to the same processing, the suffixes appended to reference symbol MB to distinguish the macroblocks MB composing one screen from each other are omitted.

As shown in the figure, the block-flatness detection section 41 further divides the macroblock MB into four sub-blocks SB, i.e., sub-blocks SB₁ to SB₄.

Then, in the sub-block SB, the block-flatness detection section 41 sets a plurality of mutually overlapping areas LB each having a predetermined size smaller than the size of the sub-block SB. In the following description, the area LB having a size determined in advance is referred to as a local area LB. A local-area dynamic range LDR is defined as the dynamic range of a local area LB. To put it more concretely, the local-area dynamic range LDR of a local area LB is the difference between the maximum of pixel values of pixels in the local area LB and the minimum of the pixel values. The block-flatness detection section 41 computes a local-area dynamic range LDR of each local area LB.

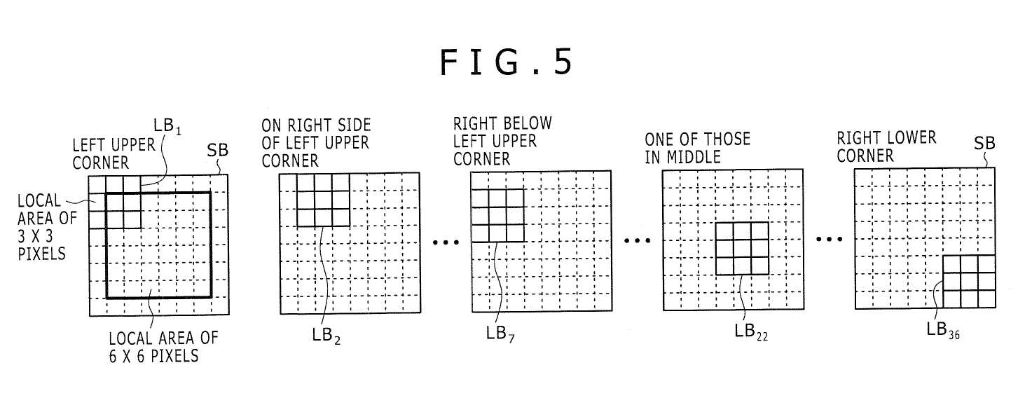

FIG. 5 is a diagram showing typical local areas LB each set at one of possible positions in a sub-block SB. As shown in the figure, the predetermined size of the local area LB is 3×3 pixels.

The local area LB set at one of possible positions in the sub-block SB can be shifted by one pixel at one time in the vertical and horizontal directions. Thus, if the predetermined size of the local area LB is 3×3 pixels, the local area LB can be set at any one of 36 possible positions in the sub-block SB. The local areas LB set at one of 36 possible positions in the sub-block SB are referred to as LB₁ to LB₃₆ respectively.

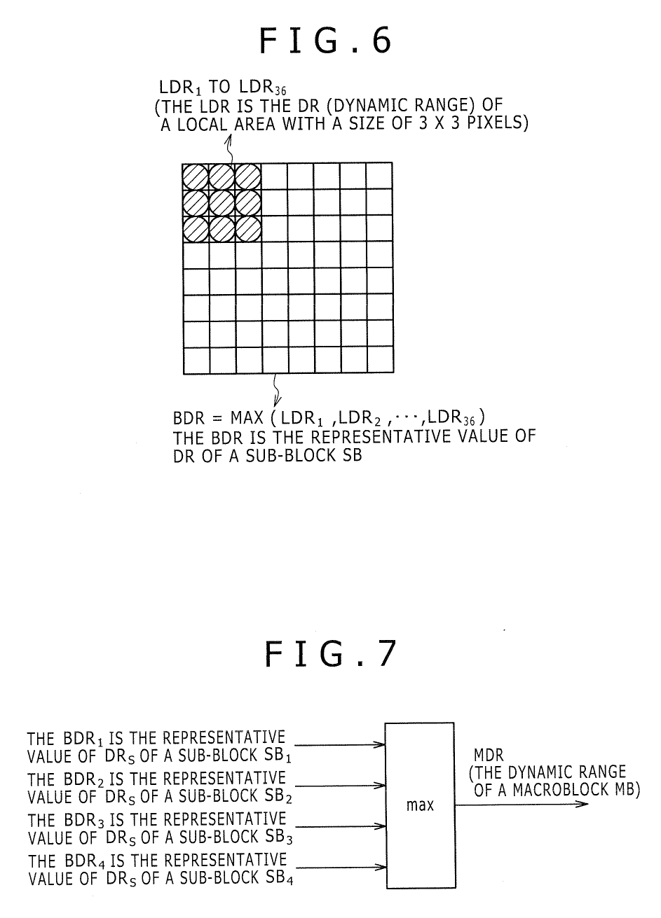

FIG. 6 is a diagram showing a typical local area LB set at one of possible positions in a sub-block SB. By shifting the local area LB by one pixel at one time in the vertical and horizontal directions as described above, 36 local areas LB (i.e., local areas LB₁ to LB₃₆) can be obtained. The block-flatness detection section 41 computes local-area dynamic ranges LDR₁ to LDR₃₆ for the local areas LB₁ to LB₃₆ respectively. Then, the block-flatness detection section 41 takes the maximum value of the local-area dynamic ranges LDR₁ to LDR₃₆ as the representative value BDR which is the representative of the local-area dynamic ranges LDR₁ to LDR₃₆ computed for the sub-block SB. That is to say, the block-flatness detection section 41 finds the representative value BDR which is expressed by the following equation:

BDR=max(LDR₁,LDR₂, . . . ,LDR₃₆)

As shown in the diagram which serves as FIG. 4, the macroblock MB is divided into four sub-blocks SB, i.e., the sub-blocks SB₁ to SB₄. The block-flatness detection section 41 carries out the processing to find the representative value BDR of a sub-block SB for each of the sub-blocks SB₁ to SB₄. To put it more concretely, the block-flatness detection section 41 finds the representative values BDR₁ to BDR₄ for the sub-blocks SB₁ to SB₄ respectively.

FIG. 7 is an explanatory diagram referred to in the following description of processing to compute a macroblock dynamic range MDR of a macroblock MB. As shown in the figure, the block-flatness detection section 41 detects the maximum of the representative values BDR₁ to BDR₄ computed for respectively four sub-blocks (i.e., the sub-blocks SB₁ to SB₄) of a macroblock MB and takes the maximum as the macroblock dynamic range MDR of the macroblock MB. In the same way as the representative value BDR, the macroblock dynamic range MDR can be expressed as follows:

MDR=max(BDR₁,BDR₂,BDR₃,BDR₄)

The block-flatness detection section 41 computes macroblock dynamic ranges MDR₁ to MDR₈₇₀₄ of the 8,704 macroblocks (i.e., the macroblocks MB₁ to MB₈₇₀₄ respectively) which are obtained as a result of dividing a picture of one screen as described above. The block-flatness detection section 41 then supplies the macroblock dynamic ranges MDR₁ to MDR₈₇₀₄ to the maximum/minimum/average computation section 42.

The maximum/minimum/average computation section 42 computes the maximum value of the macroblock dynamic ranges MDR₁ to MDR₈₇₀₄ computed for the 8,704 macroblocks (i.e., the macroblocks MB₁ to MB₈₇₀₄) respectively, the minimum value of the macroblock dynamic ranges MDR₁ to MDR₈₇₀₄ and the average value of the macroblock dynamic ranges MDR₁ to MDR₈₇₀₄. The block-flatness detection section 41 takes the maximum value, the minimum value and the average value as respectively the maximum value ldrMax, the minimum value ldrMin and the average value ldrAve which are mentioned before.

It is to be noted that the results of the processing carried out by the entire-screen feature-quantity extraction section 24 cannot be confirmed till the pixel values of pixels on the entire screen are obtained. Thus, the processing is carried out by the entire-screen feature-quantity extraction section 24 after a delay of one screen. For this reason, the entire-screen feature-quantity extraction section 24 may make use of the maximum value ldrMax, the minimum value ldrMin and the average value ldrAve, which are computed for a picture preceding the present picture by one screen, as substitutes for respectively the maximum value ldrMax, the minimum value ldrMin and the average value ldrAve which are computed for the present picture. In this way, the delay of the processing carried out by the entire-screen feature-quantity extraction section 24 can be eliminated.

### Detailed Typical Configuration of the Feature-Quantity Extraction Section 26

FIG. 8 is a block diagram showing a detailed typical configuration of a feature-quantity extraction section 26 employed in the data encoding apparatus 1.

As shown in the figure, the feature-quantity extraction section 26 employs a flatness detection section 51, an edge detection section 52, a color detection section 53, an offset computation section 54 and a swing-width computation section 55.

The maximum value ldrMax, the minimum value ldrMin and the average value ldrAve which are received from the entire-screen feature-quantity extraction section 24 as feature quantities of the macroblocks MB on the entire screen are supplied to the swing-width computation section 55. As described earlier, each of the maximum value ldrMax, the minimum value ldrMin and the average value ldrAve is computed by the entire-screen feature-quantity extraction section 24 from the macroblock dynamic ranges MDR of the macroblocks MB which are included in a frame appearing on the entire screen as the subject of the encoding process.

The rearrangement section 12 supplies macroblock data of the macroblocks MB of a frame to the flatness detection section 51, the edge detection section 52 and the color detection section 53. The frame is the same frame including the macroblocks MB, the feature quantities of which are currently being supplied by the entire-screen feature-quantity extraction section 24 to the swing-width computation section 55.

The flatness detection section 51 computes a feature quantity representing the flatness of a macroblock MB. To put it more concretely, the flatness detection section 51 computes a dynamic range MDR for each macroblock MB, the macroblock dynamic range MDR of which has been computed by the entire-screen feature-quantity extraction section 24. The flatness detection section 51 computes the dynamic range MDR of each macroblock MB for the input macroblock data. In the following description, the dynamic range MDR computed by the flatness detection section 51 for a macroblock MB determined in advance is denoted by reference notation Mdr in order to distinguish the macroblock dynamic range Mdr from the macroblock dynamic range MDR computed by the entire-screen feature-quantity extraction section 24 for the same macroblock MB. The flatness detection section 51 supplies the macroblock dynamic range Mdr computed for the macroblock MB to the offset computation section 54.

The edge detection section 52 detects the existence of an edge in a macroblock MB and supplies the result of the detection to the offset computation section 54.

To put it more concretely, in the same way as the entire-screen feature-quantity extraction section 24, the edge detection section 52 divides the macroblock MB into four sub-blocks SB, i.e., sub-blocks SB₁ to SB₄ shown in the diagram which serves as FIG. 4. Then, in the same way as the entire-screen feature-quantity extraction section 24, the edge detection section 52 sets local areas LB₁ to LB₃₆ in each of the sub-blocks SB composing the macroblock MB as explained earlier by referring to the diagram which serves as FIG. 5. Subsequently, in the same way as the entire-screen feature-quantity extraction section 24, the edge detection section 52 computes local-area dynamic ranges LDR₁ to LDR₃₆ for the local areas LB₁ to LB₃₆ respectively. Then, in the same way as the entire-screen feature-quantity extraction section 24, the edge detection section 52 takes the maximum value of the local-area dynamic ranges LDR₁ to LDR₃₆ as the representative value BDR which is the representative of the local-area dynamic ranges LDR₁ to LDR₃₆ computed for the sub-block SB. That is to say, the edge detection section 52 finds the representative value BDR which is expressed by the following equation:

BDR=max(LDR₁,LDR₂, . . . ,LDR₃₆)

It is to be noted that, in the following description, the local-area dynamic ranges LDR₁ to LDR₃₆ computed by the edge detection section 52 for respectively the local areas LB₁ to LB₃₆ each set at one of possible positions in the sub-block SB are denoted by reference notations Ldr₁ to Ldr₃₆ respectively in order to distinguish the local-area dynamic ranges Ldr₁ to Ldr₃₆ from respectively the local-area dynamic ranges LDR₁ to LDR₃₆ computed by the entire-screen feature-quantity extraction section 24 for respectively the local areas LB₁ to LB₃₆ each set at one of possible positions in the sub-block SB. By the same token, in the following description, the representative value BDR computed by the edge detection section 52 for the sub-block SB is denoted by reference notation Bdr in order to distinguish the representative value Bdr from the representative value BDR computed by the entire-screen feature-quantity extraction section 24 for the same sub-block SB.

For each of the sub-blocks SB composing the macroblock MB, the edge detection section 52 finds a local-area count en. The local-area count en is the number of local areas LB for which the following equation is satisfied:

Ldrᵢ>Ka×Bdr

where reference notation Ldr denotes the local-area dynamic range of the local area LB, reference notation Ka denotes a coefficient not greater than 1 and suffix i appended to reference notation Ldr has a value in the range of 1 to 36. Then, the edge detection section 52 compares the local-area count en with a threshold value th_en determined in advance in order to determine whether or not the local-area count en is greater than the predetermined threshold value th_en which is typically 6. If the local-area count en is found greater than the predetermined threshold value th_en, the edge detection section 52 determines that the sub-block SB has an edge.

If at least one of the four sub-blocks SB composing a macroblock MB has an edge, the edge detection section 52 determines that the macroblock MB has an edge. The edge detection section 52 supplies a determination result indicating whether or not a macroblock MB has an edge to the offset computation section 54.

The color detection section 53 detects the existence/nonexistence of a visually noticeable color in a macroblock MB and supplies the result of the detection to the offset computation section 54. The visually noticeable color, the existence/nonexistence of each of which is to be detected by the color detection section 53, is determined in advance. Typical examples of the visually noticeable color, the existence/nonexistence of each of which is to be detected by the color detection section 53, are the red color and the flesh color. The color detection section 53 counts the number of pixels each included in the macroblock MB as a pixel displaying the visually noticeable color. The color detection section 53 then compares the counted number of pixels each displaying the visually noticeable color with a threshold value th_c determined in advance in order to determine whether or not the counted number of such pixels is at least equal to the predetermined threshold value th_c. If the number of such pixels is found at least equal to the predetermined threshold value th_c, the color detection section 53 determines that the macroblock MB has the visually noticeable color. Then, the color detection section 53 provides the offset computation section 54 with the result of the determination as to whether or not the macroblock MB has the visually noticeable color.

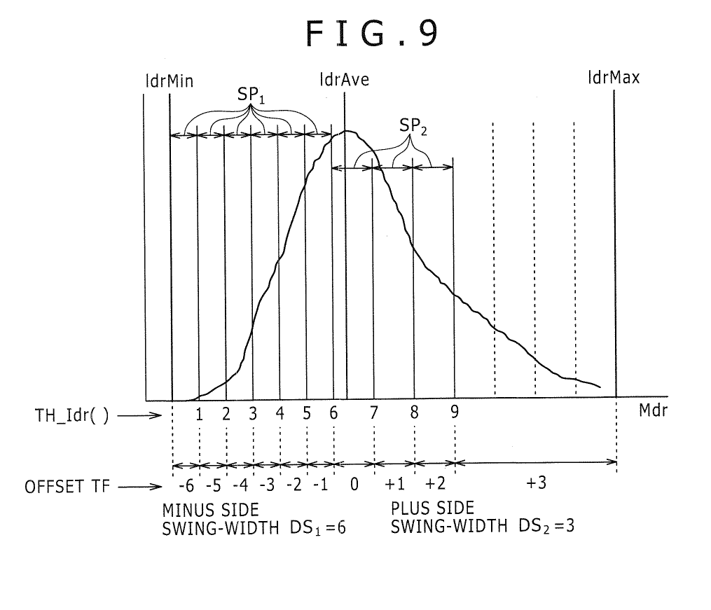

The offset computation section 54 receives the macroblock dynamic range Mdr of the macroblock MB from the flatness detection section 51. In addition, the offset computation section 54 also receives n offset threshold values (i.e., the threshold values TH_ldr (1) to TH_ldr (n)) from the swing-width computation section 55. The n offset threshold values (i.e., the threshold values TH_ldr (1) to TH_ldr (n)) are used to determine an offset Tf for the flatness of the macroblock MB of having macroblock dynamic range Mdr from the flatness detection section 51. The n offset threshold values (i.e., the threshold values TH_ldr (1) to TH_ldr (n)) are used for dividing a range included in a dynamic-range span between the maximum value ldrMax and the minimum value ldrMin into (n+1) sub-ranges as shown in a diagram which serves as FIG. 9 for n=9.

The offset computation section 54 determines the offset Tf in accordance with which one of the (n+1) sub-ranges serves as a sub-range to which the macroblock dynamic range Mdr received from the flatness detection section 51 as the macroblock dynamic range Mdr of the macroblock MB pertains. The (n+1) sub-ranges have been obtained as a result of dividing a range in a dynamic-range span between the maximum value ldrMax and the minimum value ldrMin by making use of the n offset threshold (i.e., the threshold values TH_ldr (1) to TH_ldr (n)) as described above. Then, the offset computation section 54 makes use of the determined offset Tf as an offset quantity corresponding to the flatness of the picture in order to find an offset OFFSET by subtraction or addition described below. Details of a method for determining the offset Tf will be explained later by referring to a diagram serving as FIG. 9 along with processing carried out by the swing-width computation section 55.

If the edge detection section 52 has supplied a determination result indicating the existence of an edge to the offset computation section 54, the offset computation section 54 makes use of a fixed offset Tc determined in advance as an offset quantity corresponding to the flatness of the picture to be subtracted from the offset OFFSET or, strictly speaking, to be subtracted from the offset Tf in order to find the offset OFFSET. If the edge detection section 52 has supplied a determination result indicating the nonexistence of an edge to the offset computation section 54, on the other hand, the offset computation section 54 does not subtract the fixed offset Tc from the offset OFFSET or, strictly speaking, from the offset Tf in order to find the offset OFFSET.

By the same token, if the color detection section 53 has supplied a determination result indicating the detection of a visually noticeable color to the offset computation section 54, the offset computation section 54 makes use of a fixed offset Tm determined in advance as an offset quantity corresponding to the color detection of the picture to be subtracted from the resulting offset OFFSET or, strictly speaking, to be subtracted from the offset Tf in order to find the offset OFFSET. If the color detection section 53 has supplied a determination result indicating the detection of no visually noticeable color to the offset computation section 54, on the other hand, the offset computation section 54 does not subtract the fixed offset Tm from the resulting offset OFFSET or, strictly speaking, from the offset Tf in order to find the offset OFFSET.

That is to say, in accordance with the macroblock dynamic range Mdr of the macroblock MB, the existence/nonexistence of an edge and the existence/nonexistence of the visually noticeable color, the offset computation section 54 computes the offset OFFSET (=Tf−Tc−Tm) as the result of the offset computation processing. If the edge detection section 52 has supplied a determination result indicating the nonexistence of an edge to the offset computation section 54, the offset computation section 54 does not subtract the fixed offset Tc from the offset Tf in order to find the offset OFFSET. By the same token, if the color detection section 53 has supplied a determination result indicating the detection of no visually noticeable color to the offset computation section 54, the offset computation section 54 does not subtract the fixed offset Tm from the offset Tf in order to find the offset OFFSET. Then, the offset computation section 54 supplies the offset OFFSET as the result of the offset computation processing to the quantization-scale adjustment section 27.

The swing-width computation section 55 receives the maximum value ldrMax of the macroblock dynamic ranges MDR each computed for one of macroblocks MB composing the frame serving as the subject of the encoding process, the minimum value ldrMin of the macroblock dynamic ranges MDR and the average value ldrAve of the macroblock dynamic ranges MDR.

First of all, the swing-width computation section 55 makes use of the maximum value ldrMax, the minimum value ldrMin and the average value ldrAve to determine a minus-side swing width DS₁, a minus-side threshold-value interval SP₁, a plus-side swing width DS₂ and a plus-side threshold-value interval SP₂ which are used for finding the offset Tf corresponding to a feature quantity representing flatness.

To put it more concretely, the swing-width computation section 55 computes the minus-side swing width DS₁ and the minus-side threshold-value interval SP₁ in accordance with the following equations:

DS₁=ldrAve/Ks where α≦DS₁≦β

SP₁=(ldrAve−ldrMin)/(DS₁+0.5) (1)

In addition, the swing-width computation section 55 computes the plus-side swing width DS₂ and the plus-side threshold-value interval SP₂ in accordance with the following equations:

DS₂=ldrAve/Ks where 0≦DS₂≦γ

SP₂=(ldrMax−ldrAve)/(DS₂+η+0.5) (2)

In Eqs. (1) and (2), reference symbol Ks denotes a predetermined coefficient of the swing width whereas each of reference symbols α, β, γ and η denotes a constant determined in advance. If the quantization parameter is too large, however, a picture deterioration caused by a quantization error is striking. Thus, the constant γ is set at a value smaller than the constant β so that the plus-side swing width DS₂ is set at a value which is small in comparison with the value of the minus-side swing width DS₁.

Let us take a case in which α=3, β=12, γ=3 and η=3 as an example. As a rule, the value of the expression ldrAve/Ks of Eqs. (1) is taken as the minus-side swing width DS₁. In this case, however, for DS₁<3, the value 3 is taken as the minus-side swing width DS₁. For 3≦DS₁≦12, the value of the expression ldrAve/Ks of Eqs. (1) is taken as the minus-side swing width DS₁. For 12>DS₁, the value 12 is taken as the minus-side swing width DS₁.

By the same token, the value of the expression ldrAve/Ks of Eqs. (2) is taken as the plus-side swing width DS₂. In this case, however, for 0≦DS₂≦3, the value of the expression ldrAve/Ks of Eqs. (2) is taken as the plus-side swing width DS₂ whereas, for DS₂>3, the value 3 is taken as the plus-side swing width DS₂.

Then, the swing-width computation section 55 makes use of the minimum value ldrMin of the macroblock dynamic ranges MDR, the minus-side swing width DS₁, the minus-side threshold-value interval SP₁, the plus-side swing width DS₂ and the plus-side threshold-value interval SP₂ to compute n offset threshold values, i.e., the aforementioned offset threshold values TH_ldr (1) to TH_ldr (n).

That is to say, the swing-width computation section 55 computes the n offset threshold values (i.e., the offset threshold values TH_ldr (1) to TH_ldr (n)) in accordance with Eqs. (3) and (4) given below. The offset-threshold-value count n representing the number of offset threshold values is set at the sum of the minus-side swing width DS₁ and the plus-side swing width DS₂, that is, n=(DS₁+DS₂).

TH_{—}ldr(n)=ldrMin+n×SP₁ where n=1 to DS₁ (3)

TH_{—}ldr(n)=ldrMin+DS₁×SP₁+(n−DS₁)×SP₂ where n=(DS₁+1) to (DS₁+DS₂) (4)

FIG. 9 is a diagram showing typical n offset threshold values (i.e., typical offset threshold values TH_ldr (1) to TH_ldr (n)) which are computed by the swing-width computation section 55 for the minus-side swing width DS₁ set at 6 found in accordance with Eqs. (1) and for the plus-side swing width DS₂ set at 3 found in accordance with Eqs. (2).

In accordance with Eq. (3), six offset threshold values (i.e., offset threshold values TH_ldr (1) to TH_ldr (6)) are computed by the swing-width computation section 55 from the minimum value ldrMin of the macroblock dynamic ranges MDR and the minus-side threshold-value interval SP₁. That is to say, the six offset threshold values are computed at intervals each equal to the minus-side threshold-value interval SP₁. In this case, the number of offset threshold values is set at 6 which is the value of the minus-side swing width DS₁.

By the same token, in accordance with Eq. (4), three offset threshold values (i.e., offset threshold values TH_ldr (7) to TH_ldr (9)) are computed by the swing-width computation section 55 from the offset threshold value TH_ldr (6) and the plus-side threshold-value interval SP₂. That is to say, the three offset threshold values are computed at intervals each equal to the plus-side threshold-value interval SP₂. In this case, the number of offset threshold values is set at 3 which is the value of the plus-side swing width DS₂.

Then, the swing-width computation section 55 supplies the n offset threshold values (i.e., the offset threshold values TH_ldr (1) to TH_ldr (n)) to the offset computation section 54.

On the basis of the n offset threshold values (i.e., the offset threshold values TH_ldr (1) to TH_ldr (n)), the offset computation section 54 divides a range included in a dynamic-range span between the maximum value ldrMax of the macroblock dynamic ranges MDR and the minimum value ldrMin of the macroblock dynamic ranges MDR into (n+1) sub-ranges as shown in the diagram of FIG. 9 for n=9.

Typically, the curve of distributions of the macroblock dynamic ranges Mdr for a certain frame has a protrusion at a macroblock dynamic range Mdr in close proximity to the average value ldrAve of the macroblock dynamic ranges MDR as depicted by a curve like one shown in the diagram of FIG. 9. The macroblock dynamic range Mdr supplied by the flatness detection section 51 to the offset computation section 54 as the macroblock dynamic range Mdr of the macroblock MB is always in the range between the maximum value ldrMax of the macroblock dynamic ranges MDR and the minimum value ldrMin of the macroblock dynamic ranges MDR.

The offset computation section 54 determines the offset Tf in accordance with which one of the (n+1) sub-ranges serves as a sub-range to which the macroblock dynamic range Mdr received from the flatness detection section 51 as the macroblock dynamic range Mdr of the macroblock MB pertains. The macroblock dynamic range Mdr of the macroblock MB is a feature quantity representing the flatness of the macroblock MB.

If the macroblock dynamic range Mdr supplied by the flatness detection section 51 to the offset computation section 54 as the macroblock dynamic range Mdr of the macroblock MB is between the offset threshold values TH_ldr (6) and TH_ldr (7) which flank a sub-range including the average value ldrAve of the macroblock dynamic ranges MDR for example, the offset computation section 54 sets the offset Tf at 0, that is, Tf=0.

If the macroblock dynamic range Mdr supplied by the flatness detection section 51 to the offset computation section 54 as the macroblock dynamic range Mdr of the macroblock MB is between the offset threshold values TH_ldr (5) and TH_ldr (6) for example, the offset computation section 54 sets the offset Tf at −1, that is, Tf=−1. If the macroblock dynamic range Mdr supplied by the flatness detection section 51 to the offset computation section 54 as the macroblock dynamic range Mdr of the macroblock MB is between the offset threshold values TH_ldr (7) and TH_ldr (8) for example, the offset computation section 54 sets the offset Tf at +1, that is, Tf=+1.

If the macroblock dynamic range Mdr supplied by the flatness detection section 51 to the offset computation section 54 as the macroblock dynamic range Mdr of the macroblock MB is smaller than the offset threshold values TH_ldr (1) for example, the offset computation section 54 sets the offset Tf at −6, that is, Tf=−6. If the macroblock dynamic range Mdr supplied by the flatness detection section 51 to the offset computation section 54 as the macroblock dynamic range Mdr of the macroblock MB is greater than the offset threshold values TH_ldr (9) for example, the offset computation section 54 sets the offset Tf at +3, that is, Tf=+3.

In this embodiment, the range starting from the minimum value ldrMin of the macroblock dynamic ranges MDR is divided into (n+1) sub-ranges as described above. It is to be noted, however, that instead of dividing the range starting from the minimum value ldrMin of the macroblock dynamic ranges MDR into (n+1) sub-ranges, a range starting at the average value ldrAve of the macroblock dynamic ranges MDR and ending at the maximum value ldrMax of the macroblock dynamic ranges MDR can also be divided into (n+1) sub-ranges.

### Quantization-Parameter Determination Processing

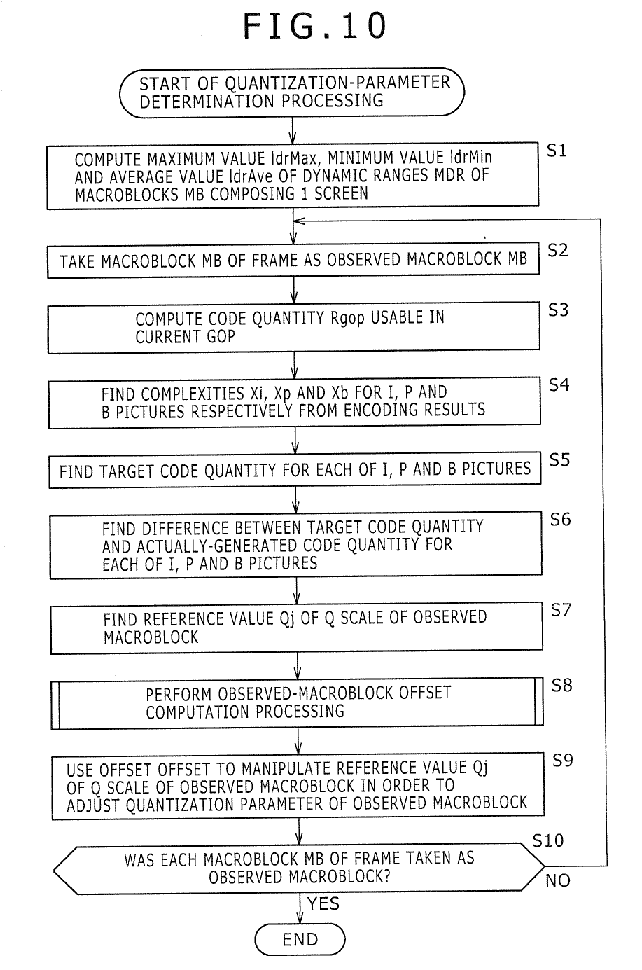

FIG. 10 shows an explanatory flowchart referred to in the following description of quantization-parameter determination processing carried out by the data encoding apparatus 1.

When input picture data of one screen is received by the data encoding apparatus 1, the data encoding apparatus 1 begins the execution of the quantization-parameter determination processing at a step S1 of the flowchart. At the step S1, the entire-screen feature-quantity extraction section 24 computes entire-screen feature quantities and supplies the entire-screen feature quantities to the feature-quantity extraction section 26. To put it in detail, the entire-screen feature-quantity extraction section 24 computes the maximum value ldrMax of the macroblock dynamic ranges MDR of pixel values computed for all pixels on the entire screen, the minimum value ldrMin of the macroblock dynamic ranges MDR and the average value ldrAve of the macroblock dynamic ranges MDR, supplying the maximum value ldrMax, the minimum value ldrMin and the average value ldrAve to the feature-quantity extraction section 26.

Then, at the next step S2, the quantization-scale computation section 25 takes a predetermined macroblock MB of a frame, the entire-screen feature quantities of which are generated by the entire-screen feature-quantity extraction section 24, as an observed macroblock MB. The observed macroblock MB is a macroblock MB selected from macroblocks MB composing the frame, the entire-screen feature quantities of which are generated by the entire-screen feature-quantity extraction section 24. The observed macroblock MB is a macroblock MB output by the rearrangement section 12.

Then, at the next step S3, the quantization-scale computation section 25 computes a code quantity Rgop which can be used in the current GOP in accordance with Eq. (5).

Rgop=(ni+np+nb)×(bit_rate/picture_rate) (5)

In the above equation, reference symbol ni denotes an I-picture count representing the number of I pictures still left in the current GOP. By the same token, reference symbol np denotes a P-picture count representing the number of P pictures still left in the current GOP. In the same way, reference symbol nb denotes a B-picture count representing the number of B pictures still left in the current GOP. In addition, reference notation bit_rate denotes a target bit rate whereas reference notation picture_rate denotes a picture rate.

Then, at the next step S4, the quantization-scale computation section 25 computes the picture complexity Xi of the I picture, the picture complexity Xp of the P picture and the picture complexity Xb of the B picture from encoding results in accordance with Eqs. (6) as follows:

Xi=Ri×Qi

Xp=Rp×Qp

Xb=Rb×Qb (6)

In the above equations, reference notation Ri denotes a result of a process to encode the I picture. By the same token, reference notation Rp denotes a result of a process to encode the P picture. In the same way, reference notation Rb denotes a result of a process to encode the B picture. In addition, reference notation Qi denotes the average value of Q scales in all macroblocks MB of the I picture. By the same token, reference notation Qp denotes the average value of Q scales in all macroblocks MB of the P picture. In the same way, reference notation Qb denotes the average value of Q scales in all macroblocks MB of the B picture.

Then, at the next step S5, the quantization-scale computation section 25 makes use of the results of the processes carried out in accordance with Eqs. (5) and (6) to compute target code quantities Ti, Tp and Tb for the I, P and B pictures respectively in accordance with Eqs. (7) as follows:

Ti=max{(Rgop/(1+((Np×Xp)/(Xi×Kp))+((Nb×Xb)/(Xi×Kb)))),(bit_rate/(8×picture))}

Tp=max{(Rgop/(Np+(Nb×Kp×Xb)/(Kb×Xp))),(bit_rate/(8×picture))}

Tb=max{(Rgop/(Nb+(Np×Kb×Xp)/(Kp×Xb))),(bit_rate/(8×picture))} (7)

In the above equations, reference symbol Np denotes a P-picture count representing the number of P pictures still left in the current GOP. By the same token, reference symbol Nb denotes a B-picture count representing the number of B pictures still left in the current GOP. In addition, each of reference symbols Kp and Kb denotes a coefficient. For example, the coefficients Kp and Kb have respectively the following typical values: Kp=1.0 and Kb=1.4.

Then, at the next step S6, three virtual buffers are used for the I, P and B pictures respectively to manage differences between the target code quantities Ti, Tp and Tb computed in accordance with Eqs. (7) and actually-generated-code quantities. That is to say, the amount of data accumulated in each of the virtual buffers is fed back and used as a basis on which the quantization-scale computation section 25 sets the reference value Qⱼ of the Q scale for the observed macroblock MB so as that the actually-generated-code quantities approach their respective target code quantities Ti, Tp and Tb.

If the type of the current picture indicates that the current picture is a P picture for example, the difference d_{p, j} between the target code quantity Tp and the actually-generated-code quantity (where suffix j is a number assigned to the macroblock MB on the P picture) is found in accordance with Eq. (8) as follows:

d_{p,j}=d_{p,0}+B_{p,j-1}((Tp×(j−1))/MB_{—}cnt) (8)

In the above equation, reference symbol d_{p,0} denotes the initial fullness of the virtual buffer. Reference symbol B_{p, j-1} denotes the total quantity of codes accumulated in the virtual buffer as codes including the code of the (j−1)th macroblock MB. Reference symbol MB_cnt denotes a MB (macroblock) count representing the number of macroblocks MB in the picture.

Then, at the next step S7, the quantization-scale computation section 25 makes use of the difference d_{p, j} to find the reference value Qⱼ of the Q scale for the observed macroblock MB in accordance with Eq. (9) as follows:

Qⱼ=(dⱼ×31)/r (9)

In the above equation, symbol r represents an equation as follows: r=2×bit_rate/picture_rate. Reference symbol dⱼ denotes the difference d_{p, j}. In the following description, the difference d_{p, j} is referred to simply as a difference dⱼ.

Then, at the next step S8, the feature-quantity extraction section 26 carries out an offset computation process to compute the offset OFFSET of the observed macroblock MB. The feature-quantity extraction section 26 supplies the offset OFFSET of the observed macroblock MB to the quantization-scale adjustment section 27 as a result of the offset computation process.

Then, at the next step S9, the quantization-scale adjustment section 27 makes use of the offset OFFSET to manipulate the reference value Qⱼ of the quantization scale of the observed macroblock MB in order to adjust the quantization parameter of the observed macroblock MB. That is to say, the quantization-scale adjustment section 27 finds Qⱼ′ (=Qⱼ+OFFSET) where reference symbol Qⱼ denotes the reference value of the quantization scale of the observed macroblock MB whereas reference symbol Q′ⱼ denotes the adjusted reference value of the quantization scale of the observed macroblock MB. Then, the quantization-scale adjustment section 27 supplies the adjusted reference value Q′ⱼ of the quantization scale of the observed macroblock MB to the quantization section 15.

Subsequently, at the next step S10, the quantization-scale computation section 25 produces a result of determination as to whether or not the frame, the entire-screen feature quantities of which are generated by the entire-screen feature-quantity extraction section 24, includes a macroblock MB not taken yet as an observed macroblock MB.

If the determination result produced by the quantization-scale computation section 25 at the step S10 indicates that the frame, the entire-screen feature quantities of which are generated by the entire-screen feature-quantity extraction section 24, includes a macroblock MB not taken yet as an observed macroblock MB, the flow of the quantization-parameter determination processing goes back to the step S2. At the step S2, the quantization-scale computation section 25 selects another macroblock MB not taken yet as an observed macroblock MB from macroblocks MB of the frame, the entire-screen feature quantities of which are generated by the entire-screen feature-quantity extraction section 24, and takes the selected macroblock MB as an observed macroblock MB. Then, the processes of the steps S3 to S10 are repeated. As a matter of fact, the processes of the steps S2 to S10 are carried out repeatedly as long as the determination result produced by the quantization-scale computation section 25 at the step S10 indicates that the frame, the entire-screen feature quantities of which are generated by the entire-screen feature-quantity extraction section 24, includes a macroblock MB not taken yet as an observed macroblock MB.

As the determination result produced by the quantization-scale computation section 25 at the step S10 indicates that the frame, the entire-screen feature quantities of which are generated by the entire-screen feature-quantity extraction section 24, no longer includes a macroblock MB not taken yet as an observed macroblock MB, on the other hand, the quantization-parameter determination processing is terminated.

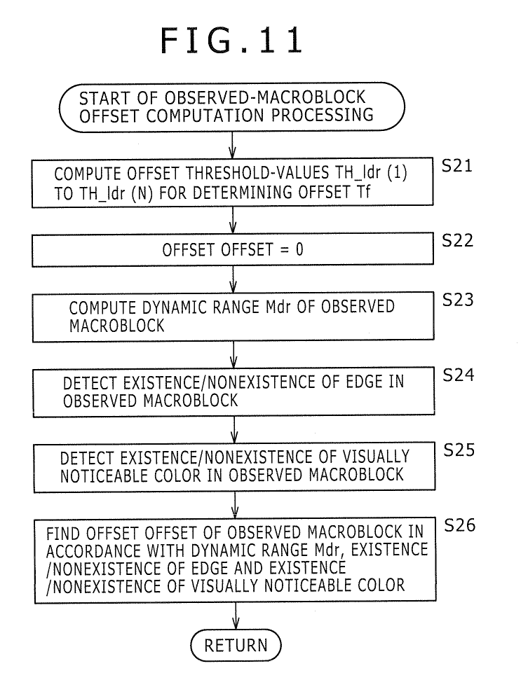

FIG. 11 shows an explanatory flowchart referred to in the following description of offset computation processing which is the process carried out by the feature-quantity extraction section 26 at the step S8 of the flowchart shown in FIG. 10 to compute the offset OFFSET of a macroblock MB.

As shown in the figure, the flowchart begins with a step S21 at which the swing-width computation section 55 computes the n offset threshold values (i.e., the offset threshold values TH_ldr (1) to TH_ldr (n)) to be used for determining the offset Tf. To put it in detail, the swing-width computation section 55 determines the minus-side swing width DS₁, the minus-side threshold-value interval SP₁, the plus-side swing width DS₂ and the plus-side threshold-value interval SP₂ in accordance with Eqs. (1) and (2). Then, the swing-width computation section 55 computes the n offset threshold values (i.e., the offset threshold values TH_ldr (1) to TH_ldr (n)) on the basis of the minus-side swing width DS₁, the minus-side threshold-value interval SP₁, the plus-side swing width DS₂ and the plus-side threshold-value interval SP₂ in accordance with Eqs. (3) and (4).

Subsequently, at the next step S22, the flatness detection section 51 initializes the offset OFFSET set by the feature-quantity extraction section 26 by setting the offset OFFSET at 0.

Then, at the next step S23, the flatness detection section 51 computes the macroblock dynamic range Mdr of the observed macroblock MB and supplies the macroblock dynamic range Mdr to the offset computation section 54.

To put it more concretely, the flatness detection section 51 divides the observed macroblock MB into four sub-blocks SB, i.e., sub-blocks SB₁ to SB₄, and sets local areas LB₁ to LB₃₆ in each of the sub-blocks SB₁ to SB₄. Then, the flatness detection section 51 computes local-area dynamic ranges Ldr₁ to Ldr₃₆ for the local areas LB₁ to LB₃₆ respectively. Subsequently, the flatness detection section 51 takes the maximum value of the local-area dynamic ranges Ldr₁ to Ldr₃₆ as the representative value Bdr which is the representative of the local-area dynamic ranges Ldr₁ to Ldr₃₆ computed for the sub-block SB. That is to say, the block-flatness detection section 41 finds the representative value Bdr which is expressed by the following equation:

Bdr=max(Ldr₁,Ldr₂, . . . ,Ldr₃₆)

Finally, the flatness detection section 51 detects the maximum of the representative values Bdr₁ to Bdr₄ computed for respectively four sub-blocks (i.e., the sub-blocks SB₁ to SB₄) of the observed macroblock MB and takes the maximum as the macroblock dynamic range Mdr of the observed macroblock MB. In the same way as the representative value Bdr, the macroblock dynamic range Mdr can be expressed as follows:

Mdr=max(Bdr₁,Bdr₂,Bdr₃,Bdr₄)

Then, at the next step S24, the edge detection section 52 detects the existence/nonexistence of an edge in the observed macroblock MB and supplies the result of the detection to the offset computation section 54.

To put it more concretely, the edge detection section 52 divides the observed macroblock MB into four sub-blocks SB, i.e., sub-blocks SB₁ to SB₄, as described above and sets local areas LB to LB₁ LB₃₆ in each of the sub-blocks SB₁ to SB₄. Then, the edge detection section 52 computes local-area dynamic ranges Ldr₁ to Ldr₃₆ for the local areas LB₁ to LB₃₆ respectively. Subsequently, for each of the sub-blocks SB composing the observed macroblock MB, the edge detection section 52 finds a local-area count en. The local-area count en is the number of local areas LB for which the following equation is satisfied:

Ldrᵢ>Ka×Bdr

where reference notation Ldr denotes the dynamic range of the local area LB, reference notation Ka denotes a coefficient not greater than 1 and suffix i appended to reference notation Ldr has a value in the range of 1 to 36. Then, the edge detection section 52 compares the local-area count en with a threshold value th_en determined in advance in order to determine whether or not the local-area count en is greater than the threshold value th_en which is typically 6. If the local-area count en is found greater than the threshold value th_en, the edge detection section 52 determines that the sub-block SB has an edge. If at least one of the four sub-blocks SB composing the observed macroblock MB has an edge, the edge detection section 52 determines that the observed macroblock MB has an edge. The edge detection section 52 supplies a determination result indicating whether or not the observed macroblock MB has an edge to the offset computation section 54.

Then, at the next step S25, the color detection section 53 detects the existence/nonexistence of a visually noticeable color in the observed macroblock MB and supplies the result of the detection to the offset computation section 54. To put it more concretely, the color detection section 53 counts the number of pixels each included in the observed macroblock MB as a pixel displaying the visually noticeable color. The color detection section 53 then compares the counted number of pixels each displaying the visually noticeable color with a threshold value th_c determined in advance in order to determine whether or not the counted number of such pixels is at least equal to the predetermined threshold value th_c. If the number of such pixels is found at least equal to the threshold value th_c, the color detection section 53 determines that the observed macroblock MB has the visually noticeable color.

It is to be noted that the processes of the steps S23 to S25 can also be carried out concurrently.

Then, at the next step S26, the offset computation section 54 finds the offset OFFSET of the observed macroblock MB in accordance with the macroblock dynamic range Mdr of the observed macroblock MB, the result of detecting the existence/nonexistence of an edge in the observed macroblock MB and the result of detecting the existence/nonexistence of a visually noticeable color in the observed macroblock MB. Subsequently, the offset computation section 54 supplies the offset OFFSET of the observed macroblock MB to the quantization-scale adjustment section 27.

To put it more concretely, the offset computation section 54 determines the offset Tf in accordance with which one of the (n+1) sub-ranges serves as a sub-range to which the macroblock dynamic range Mdr received from the flatness detection section 51 as the macroblock dynamic range Mdr of the macroblock MB pertains. The (n+1) sub-ranges have been obtained as a result of dividing a range in a span between the maximum value ldrMax and the minimum value ldrMin by making use of the n offset threshold (i.e., the threshold values TH_ldr (1) to TH_ldr (n)) as described above. In addition, the offset computation section 54 determines whether or not to subtract the fixed offset Tc from the resulting offset OFFSET in accordance with the result of detecting the existence of an edge in the observed macroblock MB and to subtract the fixed offset Tm from the resulting offset OFFSET in accordance with the result of detecting the exhibition of a visually noticeable color in the observed macroblock MB. Then, the offset computation section 54 sets the offset OFFSET at the offset Tf after subtracting the fixed offset Tc and/or the fixed offset Tm if necessary from the offset Tf.

At the step S26, the offset computation section 54 supplies the offset OFFSET obtained as a result of the process carried out at this step to the quantization-scale adjustment section 27, terminating the offset computation processing performed as the process of the step S8 of the flowchart shown in FIG. 10. As the offset computation section 54 terminates the offset computation processing represented by the flowchart shown in FIG. 11, the flow of the quantization-parameter determination processing represented by the flowchart shown in FIG. 10 goes on to the step S9.

In accordance with the flow of quantization-parameter determination processing described above, a large code quantity is allocated to an I picture. In addition, a large code quantity is also allocated to a flat portion included in a picture to serve as a portion in which visual deteriorations are easily noticeable. It is thus possible carry out code-quantity control and quantization control which suppress deteriorations of the picture quality at a bit rate determined in advance.

In addition, according to the quantization-parameter determination processing, in place of a variance used as a feature quantity in accordance with Japanese Patent Laid-open No. 2009-200871 described in the paragraph with a title of “Background of the Invention,” the macroblock dynamic range Mdr is used to extract high-frequency components of the macroblock MB. As described earlier, the macroblock dynamic range Mdr is the maximum of the representative values Bdr which are each the maximum value of the local-area DRs (dynamic ranges) Ldr each computed for one of the local areas LB. Thus, it is possible to take each of the feature quantities for adjusting the quantization parameter as a feature quantity which matches the actual visual sense of a human being.

### EFFECT OF THE INVENTION

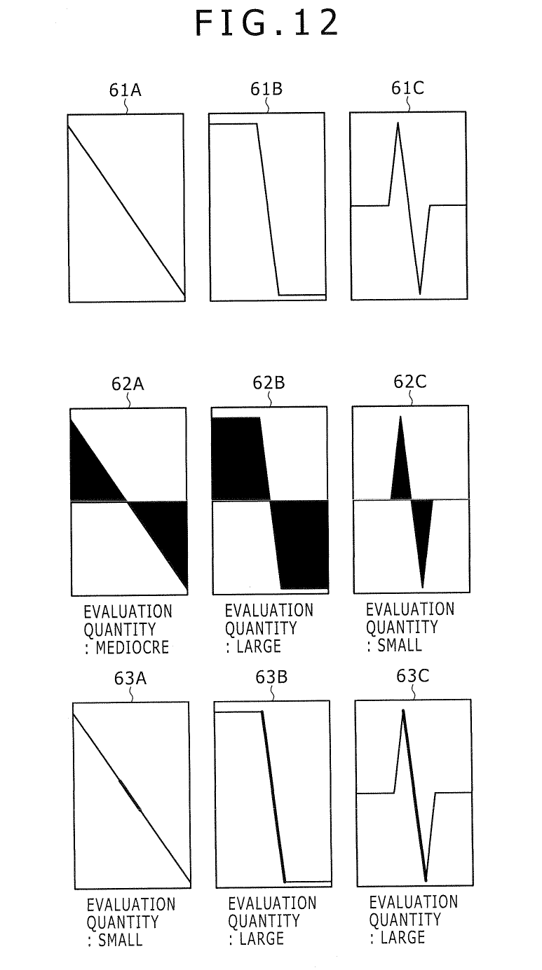

FIG. 12 is an explanatory diagram referred to in the following description of effects provided by the present invention. By referring to this figure, the following description explains a difference between the existing case in which a variance is used as a feature quantity for adjusting the quantization parameter and a case in which the macroblock dynamic range Mdr is used as a feature quantity for adjusting the quantization parameter. As described earlier, the macroblock dynamic range Mdr is the maximum of the representative values Bdr which are each the maximum value of the local-area DRs (dynamic ranges) Ldr each computed for one of the local areas LB.

Each of graphs 61A to 61C shown in the diagram serving as FIG. 12 is an input waveform of pixel values of pixels arranged along one line stretched in the horizontal direction on a macroblock MB. The graph 61A is a typical waveform representing smooth changes of the pixel values. The graph 61B is a typical waveform showing a one-directional abrupt change of a pixel value at a certain position on the line stretched in the horizontal direction. The graph 61C is a typical waveform showing upward-directional and downward-directional abrupt swings of pixel values at a segment on the line stretched in the horizontal direction.

Graphs 62A to 62C shown in the diagram serving as FIG. 12 represent evaluation quantities each computed for the existing case of making use of the variance as a feature quantity for the waveforms represented by the graphs 61A to 61C respectively.

Since the feature quantity referred to as the variance is a feature quantity representing the product of an edge size and an edge count (that is, edge size×edge count), the areas of black-colored portions represent the evaluation quantity. Thus, with the variance used as a feature quantity, the evaluation quantity for the waveform represented by the graph 61C has a small value as depicted by the graph 62C shown in the diagram serving as FIG. 12 in spite of the fact that the an abrupt edge is included. Accordingly, if the variance is used as a feature quantity for adjusting the quantization parameter, the evaluation quantity does not necessarily represent the size of a visually noticeable edge. As a matter of fact, in some cases, the evaluation quantity obtained by making use of the variance as a feature quantity for adjusting the quantization parameter is undesirably the opposite to the visual evaluation quantity.

On the other hand, graphs 63A to 63C shown in the diagram serving as FIG. 12 represent evaluation quantities each computed for a case in which the data encoding apparatus 1 makes use of the macroblock dynamic range Mdr as a feature quantity for the waveforms represented by the graphs 61A to 61C respectively. As described earlier, the macroblock dynamic range Mdr is the maximum of the representative values Bdr which are each the maximum value of the local-area DRs (dynamic ranges) Ldr each computed for one of the local areas LB.

By making use of the macroblock dynamic range Mdr which is the maximum value of the local-area DRs (dynamic ranges) Ldr each computed for one of the local areas LB as a feature quantity as described above, it is possible to deliberately eliminate the edge-count term of the product (edge size×edge count) implied and represented by the feature quantity referred to as the variance. That is to say, it is possible to make use of the macroblock dynamic range Mdr which is the maximum value of the local-area DRs (dynamic ranges) Ldr each computed for one of the local areas LB as a feature quantity which represents only the edge size.

As a result, as shown in the diagram serving as FIG. 12, for the waveform represented by any of the graphs 61B and 61C, the computed evaluation quantity is large. That is to say, for a visually noticeable edge, the evaluation quantity can be maximized. Thus, it is possible to take each of the feature quantities for adjusting the quantization parameter as a feature quantity which matches the actual visual sense of a human being.

### Other Examples of the Local Dynamic Range DR

In the embodiment described above, a local area LB set at one of possible positions in a sub-block SB obtained as a result of dividing a macroblock MB has a size of 3×3 pixels. However, the size of a local area LB is by no means limited to 3×3 pixels. For example, a local area LB can have a smallest size of 1×2 pixels or 2×1 pixels. In the case of a local area LB having the smallest size of 1×2 pixels or 2×1 pixels, the local-area dynamic range LDR (or Ldr) of the local area LB is the difference in pixel value between the two adjacent pixels composing the local area LB which is set at one of possible positions in the sub-block SB.

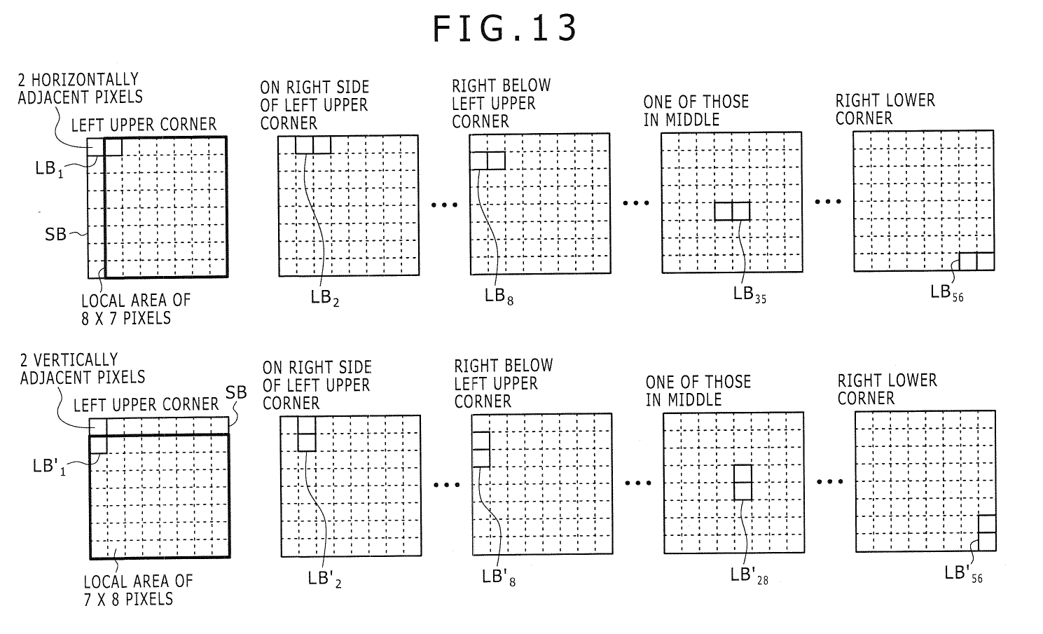

FIG. 13 is a diagram showing other typical local areas LB each set at one of possible positions in a sub-block SB. To be more specific, the figure corresponding to the diagram serving as FIG. 5 shows typical local areas LB each having the smallest size of 1×2 pixels or 2×1 pixels.

A horizontal local area LB set at one of possible positions in the sub-block SB with the minimum size of 1×2 pixels can be shifted by one pixel at one time in the vertical and horizontal directions. Thus, the horizontal local area LB can be set at any one of 56 possible positions in the sub-block SB. The horizontal local areas LB each set at one of 56 possible positions in the sub-block SB are referred to as LB₁ to LB₅₆ respectively on the top row of the diagram which serves as FIG. 13.

By the same token, a vertical local area LB set at one of possible positions in the sub-block SB with the minimum size of 2×1 pixels can be shifted by one pixel at one time in the vertical and horizontal directions. Thus, the vertical local area LB can be set at any one of 56 possible positions in the sub-block SB. The vertical local areas LB each set at one of 56 possible positions in the sub-block SB are referred to as LB₁′ to LB₅₆′ respectively as shown on the bottom row of the diagram which serves as FIG. 13.

As described above, the local-area dynamic ranges Ldr of a local area LB with the minimum size of 1×2 pixels or 2×1 pixels is the difference in pixel value between the two adjacent pixels which compose the local area LB. The maximum value of local dynamic ranges LDR (or Ldr) of the local areas LB₁ to LB₅₆ and the local areas LB₁′ to LB₅₆′ in a sub-block SB is referred to as the representative value BDR (or Bdr) of the dynamic ranges in the sub-block SB.

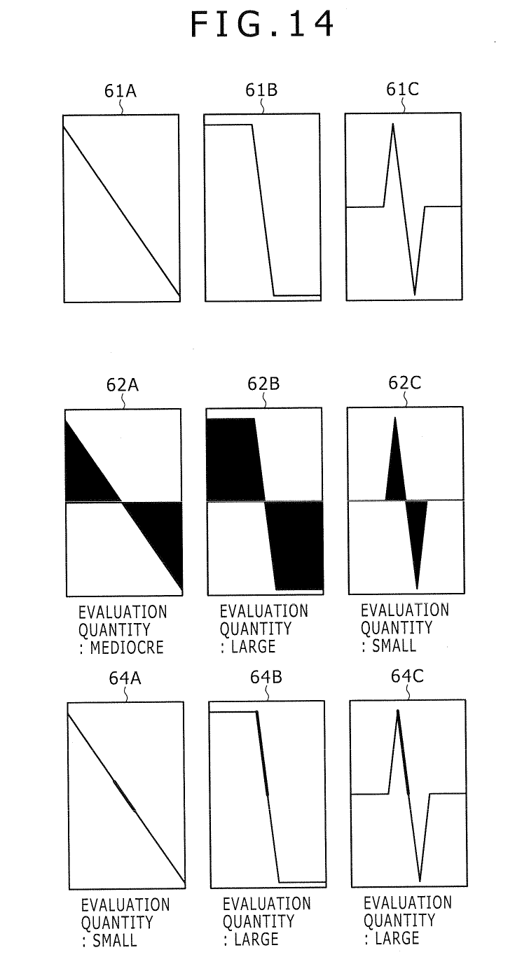

A diagram serving as FIG. 14 corresponds to the diagram which serves as FIG. 12. FIG. 14 is also an explanatory diagram referred to in the following description of a difference between the existing case in which a variance is used as a feature quantity for adjusting the quantization parameter and a case in which the macroblock dynamic range Mdr is used as a feature quantity for adjusting the quantization parameter. The macroblock dynamic range Mdr is the maximum of the representative values Bdr which are each the maximum value of the local-area DRs (dynamic ranges) Ldr each computed for one of the local areas LB. As described above, the local-area dynamic range Ldr of a local area LB with the minimum size of 1×2 pixels or 2×1 pixels is the difference in pixel value between the two adjacent pixels which compose the local area LB. FIG. 14 is a diagram provided for a local area LB having the minimum size of 1×2 pixels or 2×1 pixels whereas FIG. 12 is a diagram provided for a local area LB having the size of 3×3 pixels.

The diagram which serves as FIG. 14 shows graphs 64A to 64C replacing respectively the graphs 63A to 63C shown in the diagram which serves as FIG. 12. The graphs 64A to 64C represent evaluation quantities each computed for a case in which the representative value Bdr is also defined as the maximum value of the local-area dynamic ranges Ldr. In this case, however, each of the local-area dynamic ranges Ldr represents the difference in pixel value between merely the two adjacent pixels composing a local area LB. The remaining graphs 61A to 61C and 62A to 62C shown in the diagram serving as FIG. 14 are the same as respectively the graphs 61A to 61C and 62A to 62C shown in the diagram serving as FIG. 12.

As is obvious from the graphs 64A to 64C shown in the diagram which serves as FIG. 14, for the waveform represented by any of the graphs 61B and 61C, the computed evaluation quantity is also large as well. That is to say, for a visually noticeable edge, the evaluation quantity can also be maximized as well. Thus, it is also possible to take each of the feature quantities for adjusting the quantization parameter as a feature quantity which matches the actual visual sense of a human being.

As described above, in accordance with the quantization-parameter determination processing carried out by the data encoding apparatus 1, even for the same generated-code quantity as the existing case in which the variance is used as a feature quantity, it is possible to improve the picture quality for a macroblock MB which exhibits easily-noticeable visual deteriorations.

In addition, in accordance with the quantization-parameter determination processing, the data encoding apparatus 1 computes the maximum value ldrMax of the macroblock dynamic ranges MDR of pixel values computed for all pixels on the entire screen, the minimum value ldrMin of the macroblock dynamic ranges MDR and the average value ldrAve of the macroblock dynamic ranges MDR. Then, the data encoding apparatus 1 computes n offset threshold values (i.e., the threshold values TH_ldr (1) to TH_ldr (n)) by making use of the maximum value ldrMax, the minimum value ldrMin and the average value ldrAve. The n offset threshold values (i.e., the threshold values TH_ldr (1) to TH_ldr (n)) are used for determining the offset Tf corresponding to a feature quantity which represents the flatness of the macroblock MB. Thus, the quantization parameter can be changed adaptively in accordance with a relative degree determined by comparison of the flatness of the macroblock MB with the flatness of the entire screen to serve as the relative degree of the flatness of the macroblock MB.

As a result, the effect of the picture-dependence problem can be reduced. That is to say, in the past, in the case of a picture having a large number of high-frequency components distributed all over the screen, the average value of quantization parameters throughout the screen increases inevitably. Thus, there has been raised a problem that, even if a flat portion exhibiting easily-noticeable visual deteriorations is extracted by making use of a feature quantity such as the variance, a sufficiently effective effect of improving the picture quality cannot be obtained. In accordance with the quantization-parameter determination processing carried out by the data encoding apparatus 1, however, the effect of the problem can be reduced.

It is to be noted that the entire-screen feature-quantity extraction section 24 can be eliminated from the data encoding apparatus 1. In this case, the swing-width computation section 55 employed in the feature-quantity extraction section 26 can also be omitted as well. Without the entire-screen feature-quantity extraction section 24 and the swing-width computation section 55, the flatness detection section 51 determines the offset Tf on the basis of constant threshold values TH_ldr (1) to TH_ldr (n).

The series of processes described previously can be carried out by hardware and/or execution of software. If the series of processes described above is carried out by execution of software, programs composing the software can be installed into a computer from typically a program provider connected to a network or a removable recording medium. Typically, the computer is a computer embedded in dedicated hardware or a general-purpose personal computer or the like. In this case, the computer or the personal computer serves as the data encoding apparatus 1 described above. A general-purpose personal computer is a personal computer which can be typically made capable of carrying out a variety of functions by installing a variety of programs into the personal computer.

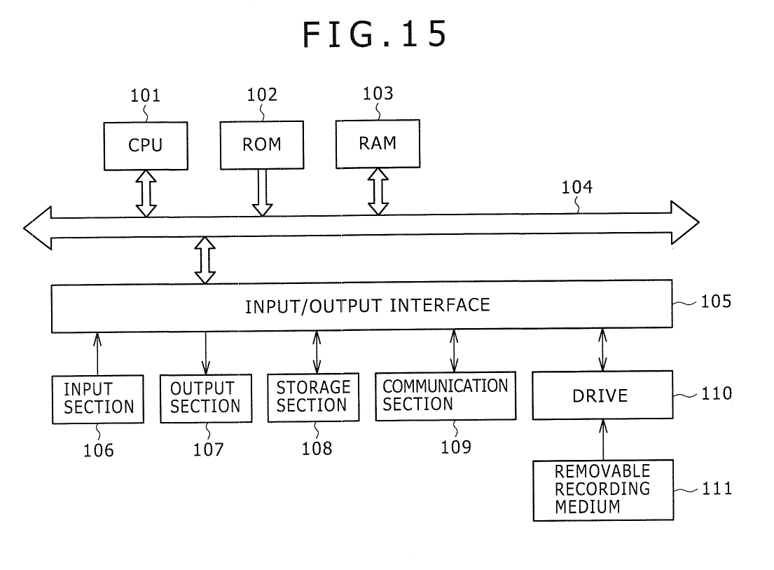

FIG. 15 is a block diagram showing a typical hardware configuration of the computer for executing the programs in order to carry out the series of processes described above.

As shown in the figure, the computer employs a CPU (Central Processing Unit) 101, a ROM (Read Only Memory) 102 and a RAM (Random Access Memory) 103 which are connected to each other by a bus 104.

The bus 104 is also connected to an input/output interface 105 as well. The input/output interface 105 is further connected to an input section 106, an output section 107, a storage section 108, a communication section 109 and a drive 110.

The input section 106 includes a keyboard, a mouse and a microphone whereas the output section 107 includes a display unit and a speaker. The storage section 108 includes a hard disk and/or a nonvolatile memory. The communication section 109 serves as the interface with the network mentioned before. The drive 110 is a section on which a removable recording medium 111 is mounted to be driven by the drive 110. The removable recording medium 111 can be a magnetic disk, an optical disk, a magneto-optical disk or a semiconductor memory.

In the computer having the configuration described above, for example, the CPU 101 loads a program stored in the storage section 108 in advance from the storage section 108 into the RAM 103 through the input/output interface 105 and the bus 104, executing the program in order to carry out the series of processes described above.

The program stored in the storage section 108 in advance is a program presented to the user by typically recording the program on, for example, the removable recording medium 111 which is used as a package medium for presenting the program to the user. As an alternative, the program stored in the storage section 108 in advance is a program downloaded from a program provider through a wire or radio communication medium. Typical examples of the wire communication medium are a local area network or the Internet whereas a typical example of the radio communication medium is a communication medium which makes use of a digital broadcasting satellite. The program presented to the user by as a program recorded on the removable recording medium 111 or the program downloaded from the program provider is then installed in the storage section 108 as follows.

The program is installed in the storage section 108 from the removable recording medium 111 by way of the input/output interface 105 when the removable recording medium 111 is mounted on the drive 110. As an alternative, the program is installed in the storage section 108 from a program provider by downloading the program from the program provider through a wire or radio communication medium into the communication section 109 which then transfers the program to the storage section 108 by way of the input/output interface 105. As another alternative, the programs can also be stored in the ROM 102 and/or the storage section 108 in advance.

It is to be noted that the program executed by the computer is a program executed to carry out processing along the time axis in an order explained in this invention specification. As an alternative, the program executed by the computer is a program executed to carry out processes concurrently or carry out processing with a required timing. Typically, the program to carry out processing with a required timing is executed when the program is invoked.

Implementations of the present invention are by no means limited to the embodiment described above. That is to say, the embodiment can be changed to a variety of any modified versions as far as the modified versions are within a range which does not depart from essentials of the present invention.

The present application contains subject matter related to that disclosed in Japanese Priority Patent Application JP 2010-035825 filed in the Japan Patent Office on Feb. 22, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A data encoding apparatus comprising:
transform encoding means for dividing input picture data into a plurality of blocks and carrying out a transform encoding process on each of said blocks in order to output transform coefficient data;
quantization-scale computation means for computing a reference value of a quantization scale of said block on the basis of a difference between a target code quantity and an actually-generated-code quantity;
feature-quantity extraction means for computing a feature quantity representing the degree of noticeability of visual deteriorations in said block and computing an offset of said quantization scale of said block on the basis of said computed feature quantity;
quantization-scale adjustment means for adjusting a reference value computed by said quantization-scale computation means as said reference value of said quantization scale on the basis of an offset computed by said feature-quantity extraction means as said offset of said quantization scale; and
quantization means for quantizing said transform coefficient data output by said transform encoding means for each of said blocks in accordance with a reference value adjusted by said quantization-scale adjustment means as said reference value of said quantization scale.

2. The data encoding apparatus according to claim 1 wherein said feature-quantity extraction means makes use of the maximum value of dynamic ranges of local areas each set at one of possible positions in said block as said feature quantity representing the degree of noticeability of visual deteriorations in said block.

3. The data encoding apparatus according to claim 2, said data encoding apparatus further having entire-screen feature-quantity extraction means for:
taking said maximum value of said dynamic ranges of said local areas each set at one of possible positions in each individual one of said blocks composing an entire screen of said input picture data as a representative value representing said individual block; and
computing a maximum of said representative values each representing one of said blocks composing said entire screen, a minimum of said representative values and an average of said representative values,
wherein said feature-quantity extraction means divides a range between a minimum computed by said entire-screen feature-quantity extraction means as said minimum of said representative values each representing an individual one of said blocks composing said entire screen and a maximum computed by said entire-screen feature-quantity extraction means as said maximum of said same representative values into a plurality of sub-ranges; and
computes said offset of said quantization scale in accordance with which one of said sub-ranges serves as a sub-range to which said maximum value of said dynamic ranges of said local areas each set at one of possible positions in said individual block pertains;

4. The data encoding apparatus according to claim 2 wherein said local area set at one of possible positions in said block is two adjacent pixels arranged in the vertical or horizontal direction.

5. The data encoding apparatus according to claim 2 wherein said feature-quantity extraction means:
detects the existence/nonexistence of an edge in said block in order to produce a detection result as a feature quantity representing the degree of noticeability of visual deteriorations in said block; and
computes also an offset of said quantization scale on the basis of said detection result indicating whether or not an edge exists in said block.

6. A data encoding method to be adopted by a data encoding apparatus configured to encode input picture data to serve as a method comprising the steps of:
dividing input picture data into a plurality of blocks and carrying out a transform encoding process on each of said blocks in order to output transform coefficient data;
computing a reference value of a quantization scale of said block on the basis of a difference between a target code quantity and an actually-generated-code quantity;
computing a feature quantity representing the degree of noticeability of visual deteriorations in said block and computing an offset of said quantization scale of said block on the basis of said computed feature quantity;
adjusting a reference value computed at said quantization-scale computation step as said reference value of said quantization scale on the basis of an offset computed at said feature-quantity extraction step as said offset of said quantization scale; and
quantizing said transform coefficient data output at said transform encoding step for each of said blocks in accordance with a reference value adjusted at said quantization-scale adjustment step as said reference value of said quantization scale.

7. A data encoding program to be executed by a computer to perform processing comprising:
a transform encoding step of dividing input picture data into a plurality of blocks and carrying out a transform encoding process on each of said blocks in order to output transform coefficient data;
a quantization-scale computation step of computing a reference value of a quantization scale of said block on the basis of a difference between a target code quantity and an actually-generated-code quantity;
a feature-quantity extraction step of computing a feature quantity representing the degree of noticeability of visual deteriorations in said block and computing an offset of said quantization scale of said block on the basis of said computed feature quantity;
a quantization-scale adjustment step of adjusting a reference value computed at said quantization-scale computation step as said reference value of said quantization scale on the basis of an offset computed at said feature-quantity extraction step as said offset of said quantization scale; and
a quantization step of quantizing said transform coefficient data output at said transform encoding step for each of said blocks in accordance with a reference value adjusted at said quantization-scale adjustment step as said reference value of said quantization scale.

8. A data encoding apparatus comprising:
transform encoding means for dividing input picture data into a plurality of blocks and carrying out a transform encoding process on each of said blocks in order to output transform coefficient data;
entire-screen feature-quantity extraction means for computing entire-screen feature quantities representing the flatness of an entire screen of said input picture data;
quantization-scale computation means for computing a reference value of a quantization scale of said block on the basis of a difference between a target code quantity and an actually-generated-code quantity;
feature-quantity extraction means for computing a feature quantity representing the flatness of said block and computing an offset of said quantization scale of said block in accordance with a relative degree determined by comparison of said flatness of said block with said flatness of said entire screen to serve as said relative degree of said flatness of said block;
quantization-scale adjustment means for adjusting a reference value computed by said quantization-scale computation means as said reference value of said quantization scale on the basis of an offset computed by said feature-quantity extraction means as said offset of said quantization scale;
quantization means for quantizing said transform coefficient data output by said transform encoding means for each of said blocks in accordance with a reference value adjusted by said quantization-scale adjustment means as said reference value of said quantization scale.

9. The data encoding apparatus according to claim 8 wherein said entire-screen feature-quantity extraction means:
takes a maximum value of the dynamic ranges of local areas each set at one of possible positions in each individual one of said blocks composing said entire screen of said input picture data as a representative value representing said individual block; and
makes use of a maximum of said representative values each representing one of said blocks composing said entire screen, a minimum of said representative values and an average of said representative values as said entire-screen feature quantities.

10. A data encoding apparatus comprising:
a transform encoding section configured to divide input picture data into a plurality of blocks and carry out a transform encoding process on each of said blocks in order to output transform coefficient data;
a quantization-scale computation section configured to compute a reference value of a quantization scale of said block on the basis of a difference between a target code quantity and an actually-generated-code quantity;
a feature-quantity extraction section configured to compute a feature quantity representing the degree of noticeability of visual deteriorations in said block and compute an offset of said quantization scale of said block on the basis of said computed feature quantity;
a quantization-scale adjustment section configured to adjust a reference value computed by said quantization-scale computation section as said reference value of said quantization scale on the basis of an offset computed by said feature-quantity extraction section as said offset of said quantization scale; and
a quantization section configured to quantize said transform coefficient data output by said transform encoding section for each of said blocks in accordance with a reference value adjusted by said quantization-scale adjustment section as said reference value of said quantization scale.

11. A data encoding apparatus comprising:
a transform encoding section configured to divide input picture data into a plurality of blocks and carry out a transform encoding process on each of said blocks in order to output transform coefficient data;
an entire-screen feature-quantity extraction section configured to compute entire-screen feature quantities representing the flatness of an entire screen of said input picture data;
a quantization-scale computation section configured to compute a reference value of a quantization scale of said block on the basis of a difference between a target code quantity and an actually-generated-code quantity;
a feature-quantity extraction section configured to compute a feature quantity representing the flatness of said block and compute an offset of said quantization scale of said block in accordance with a relative degree determined by comparison of said flatness of said block with said flatness of said entire screen to serve as said relative degree of said flatness of said block;
a quantization-scale adjustment section configured to adjust a reference value computed by said quantization-scale computation section as said reference value of said quantization scale on the basis of an offset computed by said feature-quantity extraction section as said offset of said quantization scale;
a quantization section configured to quantize said transform coefficient data output by said transform encoding section for each of said blocks in accordance with a reference value adjusted by said quantization-scale adjustment section as said reference value of said quantization scale.
